(19) United States
(12) Patent Application Publication
(10) Pub. No.: US 2015/0220504 A1
(43) Pub. Date: Aug. 6, 2015

(54) Visual Annotations for Objects

(71) Applicant: Adobe Systems Incorporated, San Jose, CA (US)

(72) Inventors: Tobias M. Bocanegra Alvarez, San Francisco, CA (US); David B. Nuescheler, Salt Lake City, UT (US)

(73) Assignee: Adobe Systems Incorporated, San Jose, CA (US)

(21) Appl. No.: 14/172,720

(22) Filed: Feb. 4, 2014

(51) Int. Cl. G06F 17/24; G06F 3/0488; G06F 3/0484

(52) U.S. Cl. CPC G06F 17/241; G06F 3/04845; G06F 3/0488

(57) ABSTRACT

Visual annotations for objects such as graphical charts, images and documents are described herein. The visual annotations may be generated by direct user interaction with an object to draw a pattern that is recognized and converted into a corresponding visual annotation. In response to the user interaction, input applied to the object is captured and analyzed to select a corresponding shape for the visual annotation that matches the captured input. Then, an annotated object is produced by rendering the visual annotation having the selected shape. Additionally, the annotation may be associated with the object by transforming parameters that define the annotation into an object-specific coordinate space. In this way, the annotation is tied to underlying data of the object and may be reconstructed in an appropriate position even if the object is modified, such as by resizing or rescaling.

### BACKGROUND

Individuals may interact with various computing resources, such as desktop applications or web applications available from service providers, to create content (e.g., documents, images, charts, graphs, etc.) and collaborate with other people. In some instances, individuals may also add annotations to content to call-out particular aspects or points of interest in the content. Generally, existing annotations supported by applications rely upon a pre-selection of annotation shapes by a user using a picker tool. A selected annotation having a selected shape (e.g., arrow, circle, etc.) may then be positioned within the content by the user. Having to make a pre-selection of an annotation shape may be disruptive to the user and may be difficult on some small form factor devices like mobile phones and tablets. Additionally, annotations made using traditional approaches may not be tied to underlying data or pixels of the content being annotated. Accordingly, if a view of the content is modified (e.g., resized or rescaled), the annotation may move unexpectedly and may end-up in an incorrect position.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

Techniques for including visual annotations with objects such as graphical charts, images and documents are described herein. The visual annotations may be generated by direct user interaction with an object presented within an application user interface to draw a pattern that is recognized and converted into a corresponding visual annotation. The user interaction may be provided as touch-based input, a designated gesture, manipulation of a cursor, stylus input, or other input techniques. In response to the user interaction, input applied to the object is captured and analyzed to select a corresponding shape for the visual annotation that matches the captured input. For instance, a pattern of points indicated by the captured input may be compared to signature patterns associated with shapes contained in library of supported shapes to identify a shape as a closest match to the captured input. Then an annotated object is produced by rendering the visual annotation using the selected shape. Additionally, the annotation may be associated with the object by transforming parameters defining the annotation into an object-specific coordinate space. In this way, the annotation may be tied to underlying data of the object and may be reconstructed in a proper position within the object even if the object is modified, such as by resizing or rescaling.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ techniques described herein.

FIG. 2 illustrates an example annotation scenario in accordance with one or more implementations.

FIG. 3 illustrates another example annotation scenario in accordance with one or more implementations.

FIG. 4 is a flow diagram depicting an example procedure for rendering and storing an annotation for an object in accordance with one or more implementations.

FIG. 5 is a flow diagram depicting an example procedure for selection of an annotation shape based on an input pattern in accordance with one or more implementations.

FIG. 6 illustrates an example scenario in which an annotated object is modified in accordance with one or more implementations.

FIG. 7 is a flow diagram depicting an example procedure for reconstruction of an annotation in a modified view in accordance with one or more implementations.

FIG. 8 illustrates an example system including various components of an example device that can be employed for one or more implementations described herein.

### DETAILED DESCRIPTION

### Overview

Existing annotations supported by applications rely upon a pre-selection of annotation shapes by a user using a picker tool. Having to make a pre-selection of an annotation shape, though, may be disruptive to the user and may be difficult on some small form factor devices like mobile phones and tablets. Additionally, annotations made using traditional approaches may not be tied to underlying data and therefore may move to unexpected locations when a view of the content is modified (e.g., resized or rescaled).

Techniques for including visual annotations with objects such as graphical charts, images and documents are described herein. The visual annotations may be generated by direct user interaction with an object presented within an application user interface to draw a pattern that is recognized and converted into a corresponding visual annotation. The user interaction may be provided as touch-based input, a designated gesture, manipulation of a cursor, stylus input, or other input techniques. In response to the user interaction, input applied to the object is captured and analyzed to select a corresponding shape for the visual annotation that matches the captured input. For instance, a pattern of points indicated by the captured input may be compared to signature patterns associated with shapes contained in library of supported shapes to identify a shape as a closest match to the captured input. Then an annotated object is produce by rendering the visual annotation using the selected shape. Additionally, the annotation may be associated with the object by transforming parameters defining to annotation into an object-specific coordinate space. In this way, the annotation may be tied to underlying data of the object and may be reconstructed in a proper position within the object even if the object is modified, such as by resizing or rescaling.

In the following discussion, an example environment is first described that may employ the techniques described herein. Example implementation details and procedures are then described which may be performed in the example environment as well as other environments. Consequently, performance of the example procedures is not limited to the example environment and the example environment is not limited to performance of the example procedures.

### Example Environment

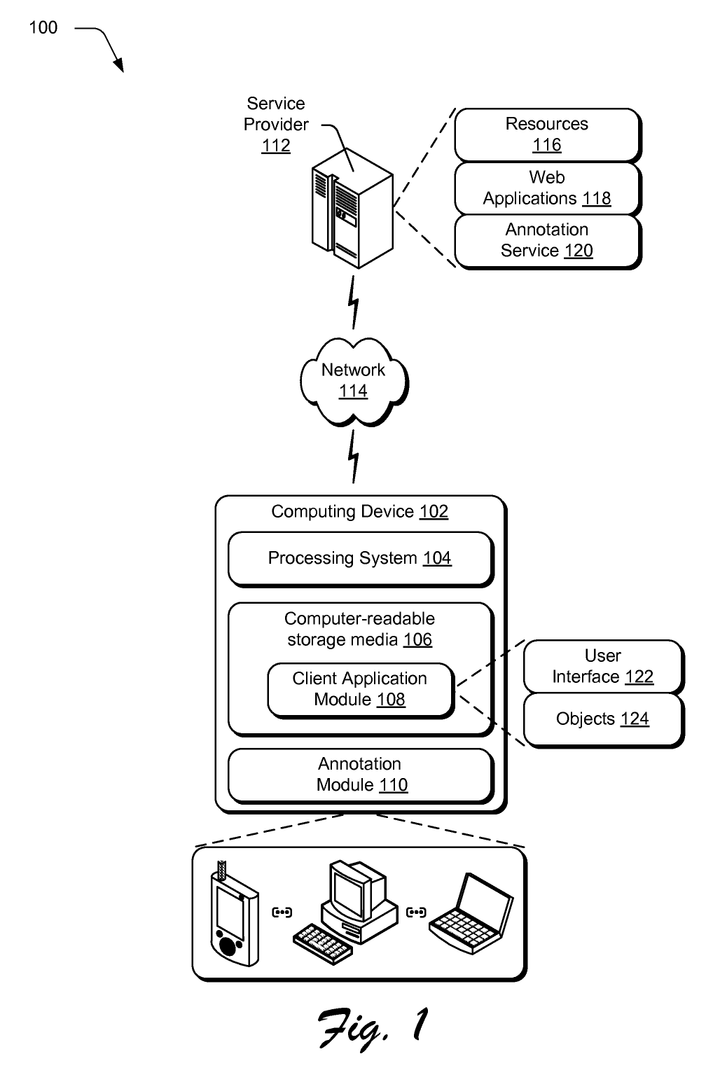

FIG. 1 is an illustration of an environment 100 in an example implementation that is operable to employ techniques described herein. The illustrated environment 100 includes a computing device 102 including a processing system 104 that may include one or more processing devices, one or more computer-readable storage media 106 and a client application module 108 embodied on the computer-readable storage media 106 and operable via the processing system 104 to implement corresponding functionality described herein. In at least some embodiments, the client application module 108 may represent a browser of the computing device operable to access various kinds of web-based resources (e.g., content and services). The client application module 108 may also represent a client-side component having integrated functionality operable to access web-based resources (e.g., a network-enabled application), browse the Internet, interact with online providers, and so forth.

The computing device 102 may also include or make use of an annotation module 110 that represents functionality operable to implement techniques for visual annotations described above and below. For instance, the annotation module 110 may be operable to capture input indicative of annotation shapes, analyze the input to distinguish between different annotation shapes, and cause insertion of an annotation having a particular shape in response to the input. Annotation techniques discussed herein may be applied to generate visual annotations for various kinds of objects including but not limited to documents, charts and graphs, photographic images, and so forth. The visual annotations may be configured as relatively simple graphics such as arrows, circles, boxes, and the like. Each visual annotation supported by the system may be mapped to a signature pattern of input that is recognizable via the annotation module 110 to distinguish between various annotation shapes included in a library or database.

Accordingly, when a user interacts with an object and draws upon the object to cause insertion of an annotation, the annotation module 110 may be configured to derive a corresponding pattern of input based on the interaction. The annotation module 110 further operates to compare the derived pattern of input to signature patterns to identify a matching pattern. A visual annotation having the matching pattern is then selected and may be added to the object. For example, a straight line pattern may be recognized as an arrow annotation whereas an arcuate pattern may be recognized as an elliptical annotation. Various other annotation shapes and graphics are also be contemplated. Additionally, the visual annotations applied to a particular object are associated with an object-specific coordinate space for the particular object, such that correct positioning/layout of the annotation may be reproduced even if the view of the object is modified in some manner. Details regarding these and other aspects of visual annotations for objects are discussed throughout this document.

The annotation module 110 may be implemented as a software module, a hardware device, or using a combination of software, hardware, firmware, fixed logic circuitry, etc. The annotation 110 may be implemented as a standalone component of the computing device 102 as illustrated. In addition or alternatively, the annotation 110 may be configured as a component of the client application module 108, an operating system, or other device application. For example, the annotation module 110 may be provided as a plug-in and/or downloadable script for a browser. The annotation module 110 may also represent script contained in or otherwise accessible via a webpage, web application, a web-based service, or other resources made available by a service provider.

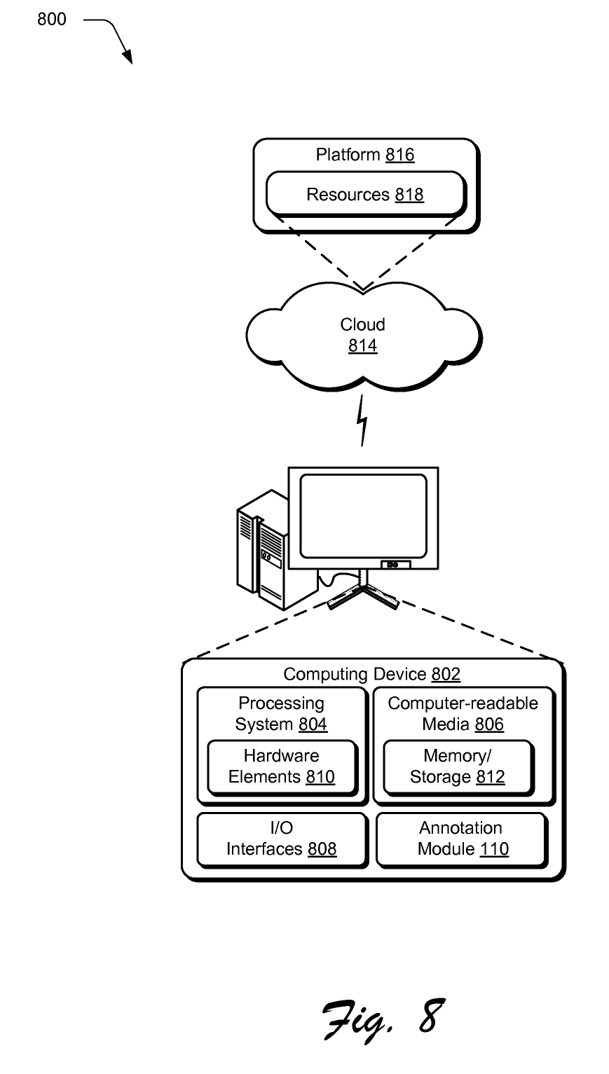

The computing device 102 may be configured as any suitable type of computing device. For example, the computing device may be configured as a desktop computer, a laptop computer, a mobile device (e.g., assuming a handheld configuration such as a tablet or mobile phone), a tablet, and so forth. Thus, the computing device 102 may range from full resource devices with substantial memory and processor resources (e.g., personal computers, game consoles) to a low-resource device with limited memory and/or processing resources (e.g., mobile devices). Additionally, although a single computing device 102 is shown, the computing device 102 may be representative of a plurality of different devices to perform operations “over the cloud” as further described in relation to FIG. 8.

The environment 100 further depicts one or more service providers 112, configured to communicate with computing device 102 over a network 114, such as the Internet, to provide a “cloud-based” computing environment. Generally, speaking a service provider 112 is configured to make various resources 116 available over the network 114 to clients. In some scenarios, users may sign-up for accounts that are employed to access corresponding resources from a provider. The provider may authenticate credentials of a user (e.g., username and password) before granting access to an account and corresponding resources 116. Other resources 116 may be made freely available, (e.g., without authentication or account-based access). The resources 116 can include any suitable combination of services and/or content typically made available over a network by one or more providers. Some examples of services include, but are not limited to, a photo editing service, a web development and management service, a collaboration service, a social networking service, a messaging service, an advertisement service, and so forth. Content may include various combinations of text, video, ads, audio, multi-media streams, animations, images, web documents, web pages, applications, device applications, and the like.

Web applications 118 represent one particular kind of resource 116 that may be accessible via a service provider 112. As mentioned, web applications 118 may be operated over a network 114 using a browser or other client application module 108 to obtain and run client-side code for the web application. In at least some implementations, a runtime environment for execution of the web application 118 is provided by the browser (or other client application module 108). The runtime environment supports web applications 118 that may be written using dynamic scripting languages, such as JavaScript, hypertext markup language revision 5 and cascading style sheets (HTML5/CSS), and/or extensible application mark-up language (XAML). Script-based web applications may operate through corresponding runtime environments supported by a device that are configured to provide respective execution environments for corresponding applications. The runtime environments may provide a common set of features, routines, and functions for compatible applications thereby offloading coding of common tasks from application development. Thus, the runtime environment can facilitate portability of web applications to different kinds of systems and architectures with little or no change to the script for the applications. Various types of runtime environments may be employed including but not limited to JAVA™ runtime environment (JRE), JavaScript engine, and Adobe™ Flash™, to name a few examples.

The service provider is further illustrated as including an annotation service 120. The annotation service 120 is representative of a server-side functionality operable to support techniques for visual annotation of objects. For example, the annotation service 120 may be configured to perform functionality that is described herein in relation to the annotation module 110 as a web-based service. In particular, the annotation service 120 may be configured to enable visual annotations as described above and below in connection with web applications 118 and/or client application modules 108 over the network 114. Moreover, the annotation service 120 may be configured to distribute annotation modules 110 for use by clients, such as by making the annotation module available for downloading over the network 114, communicating the annotation modules to computing devices for use with client application modules 108, and so forth.

In operation, a client application module 108 (or web application 118) may be executed to output a corresponding user interface 122 configured for interaction with one or more objects 124. An annotation module 110 included with the application or corresponding functionality that is otherwise accessible via the application (e.g., via the annotation service 120) may be invoked to enable visual annotations for an object presented via the user interface 122. As mentioned, the objects 124 may be content items such as documents, webpages, charts and graphs, or images that are manipulable via the particular application. For example, a desktop enterprise application may be used to create or view a business chart. In another example, a photo editing application may be invoked to touch-up a photo. Comparable interactions may also occur using web applications 118 and services provided via a service provider 112 over the network 114.

Having considered an example environment, consider now a discussion of some example details of techniques for visual annotations in accordance with one or more implementations.

Visual Annotations for Objects Implementation Details

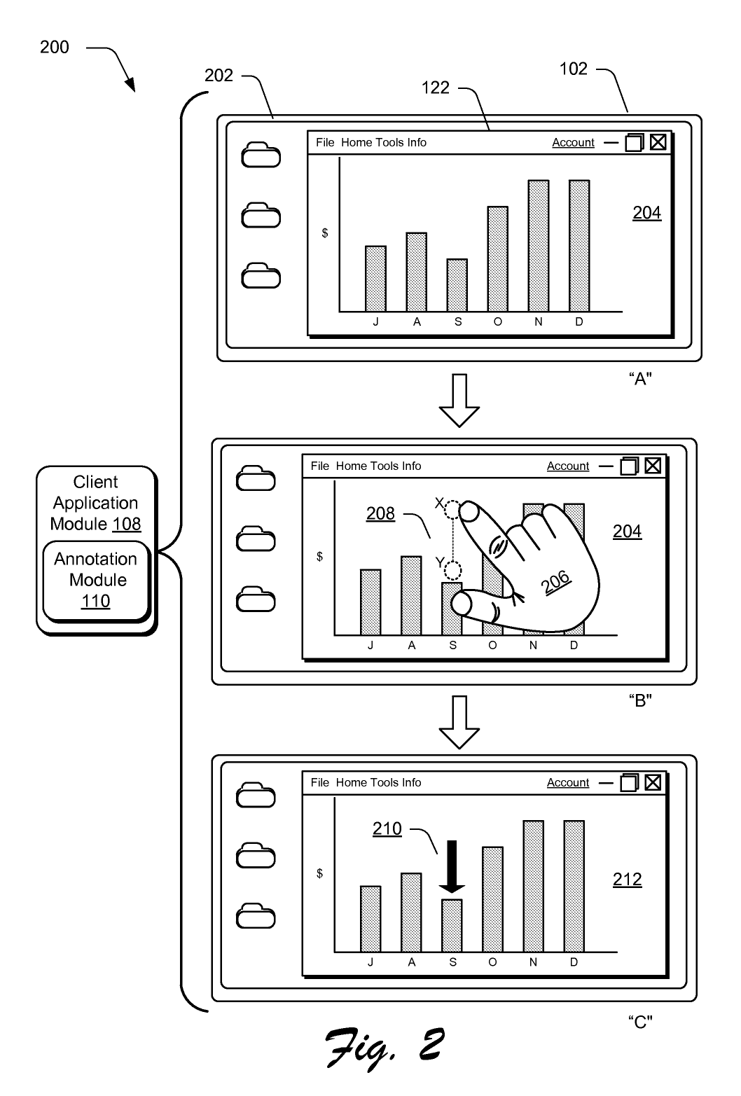

This section describes some example details of visual annotations for objects in accordance with one or more implementations. In particular, FIG. 2 depicts generally at 200 an example scenario in which an annotation is recognized and added to an object using the techniques described herein. In this example, a sequence of views of a user interface 122 are illustrated as being presented via a display device 202 associated with a computing device 102. Here, different letters “A” to “C” are used to denote the different views that may occur as part the scenario.

The scenario represents a user interface 122 output via the computing device 102 for interaction with an object 204 as depicted in view “A”. In this example, the object 204 is in the form of a bar graph. The object 204 may be created, edited, and viewed via a corresponding application, such as a client application module 108 (as shown), a web application 118, or other suitable application. In any event, the application employed for the interaction with the object 204 may include or make use of an annotation module 110 operable as described previously to facilitate insertion of annotations into the object.

In particular, the annotation module 110 may operate to capture input and recognize visual annotations based on the captured input. The input may be obtained based upon interaction of a user with the object in various ways. This may include touch-based interaction if enabled by the computing device 102 and/or display device 202. Other techniques to provide the input may also be used, some examples of which include manipulation of a cursor via an input device (e.g., mouse, keyboard, touch-pad, stylus), voice commands, camera-based gestures, and so forth. Generally, the input to cause inclusion of the visual annotation in applied through direct interaction to draw lines/shapes upon a view of the object presented in the display. This interaction may produce a plurality of discrete points of input. Analysis of a pattern of the discrete points enables the annotation module 110 to distinguish between patterns and match the patterns to a library of visual annotations that are associated with different signature patterns and shapes (e.g., arrow, ellipse, circle, square, box, bullet point, finger icon, smiley face graphic, etc.).

As represented in view “B” for example, a finger of a user hand 206 may provide touch-based input by placing and dragging the finger upon or proximate to the surface of the display device 202. Here, a drag 208 of the user finger in generally a straight line from a point x to a point y is illustrated. Accordingly, an input pattern including a plurality of discrete points that are substantially aligned in a straight line may be identified by the annotation module 110. The annotation module 110 may then look-up a corresponding visual annotation form a library of annotations using the identified pattern to distinguish between annotations having different shapes/characteristics. In the example of FIG. 2, the input pattern of a straight line may be mapped to an arrow annotation. Accordingly, as represented in view “C,” an arrow annotation 210 for the object is rendered along the path from point x to point y, which produces the annotated object 212. Details of techniques and algorithms that may be used to recognize annotations from different patterns are described in relation to example procedures in the following section. Additionally, the following section also include details regarding techniques to store annotations relative to an object specific-coordinate space, which facilitates positioning and reconstruction of the annotation in different views of the object.

In this manner just described, a user is able to “directly” draw upon an object to produce a desired annotation. Different patterns of input may be associated with different visual annotations. The patterns may be fairly simple such as a line pattern for an arrow, an arc for an ellipse, an l-shape for a box, and so forth. The different patterns may be recognized based on relatively coarse drawing of the particular patterns and detection of the patterns by the annotation module 110. Accordingly, annotations may by triggered by drawing of general shapes directly upon an object and the user interaction may be somewhat imprecise. The user may therefore learn how to provide input to generate the different patterns and then selectively reproduce the input for different annotations as appropriate to cause insertion of a desired annotation. In one or more implementations, the annotation module 110 provides a default library of visual annotations and/or may also enable custom-defined annotations by mapping user-selected patterns to corresponding graphics and adding these mappings to the library.

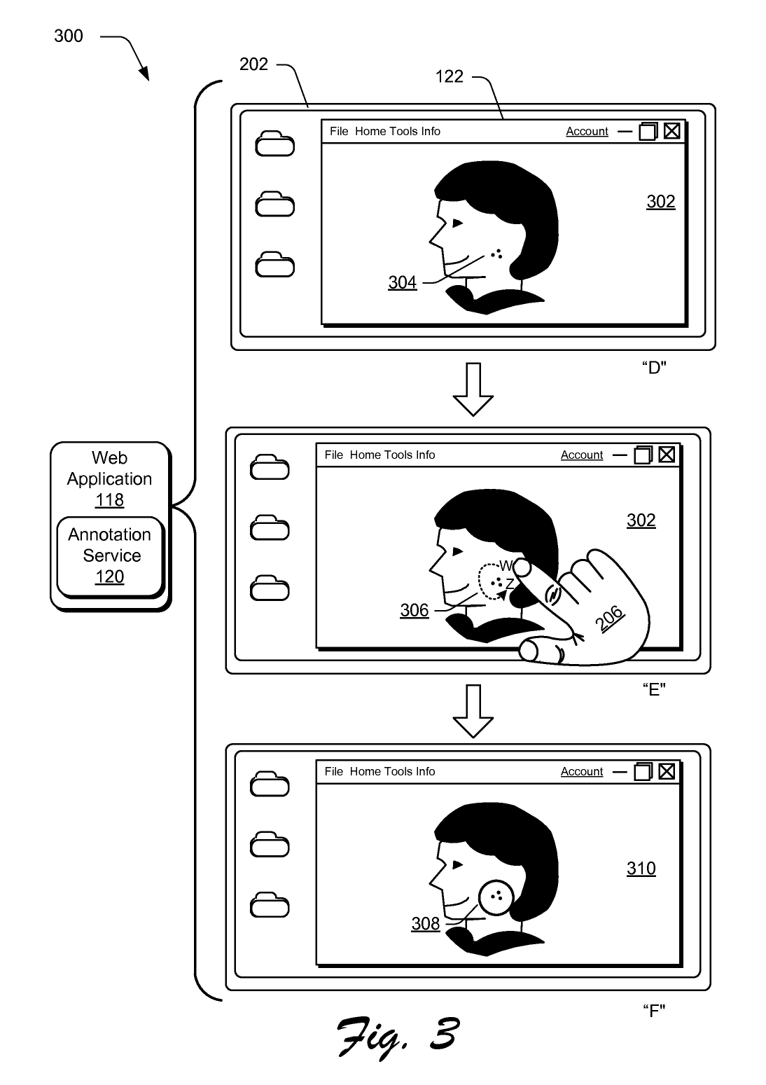

To further illustrate, FIG. 3 depicts generally at 300 an additional example scenario in which an annotation is recognized and added to an object using the techniques described herein. In this example, a sequence of views of a user interface 122 are again illustrated as being presented via a display device 202 associated with a computing device 102. Here, different letters “D” to “F” are used to denote the different views that may occur as part the scenario.

The scenario represents a user interface 122 output via the computing device 102 for interaction with an object 302 as depicted in view “D”. Here, the object 302 is in the form of photographic image of a person face. In this example, a web application 118 such as a photo editing application may be used to edit and view via a corresponding image object. As further represented, the web application 118 may include or make use of an annotation service 120 operable as described previously to facilitate insertion of annotations into the object. Naturally, a comparable scenario may occur using a client application module 108 and/or an annotation module 110 to implement a visual annotation. In either case, a point of interest 304 may be annotated. The point of interest 304 in this example is configured as a blemish region in the photographic image of a person face that includes defects such as pimples, dirt, acne etc. The annotation service 120 or annotation module 110 may accordingly be invoked to annotate the point of interest 304. For example, a user may want to call-out the blemish region to another user so that a touch-up or correction operation can be performed to remove or diminish the appearance of the blemish.

In order to select the point of interest 304, a finger of a user hand 206 may provide touch-based input by placing and dragging the finger upon or proximate to the surface of the display device 202 as shown in view “E”. In particular, a circular drag 306 of the user's finger is illustrated generally around the blemish region from a point w to a point z. Accordingly, an input pattern including a plurality of discrete points that are substantially arcuate or circular may be identified by the annotation module 110. The annotation module 110 may then look-up a corresponding visual annotation form a library of annotations using the identified pattern to distinguish between annotations having different shapes/characteristics. In the example of FIG. 3, the input pattern of an arcuate or circular path may be mapped to a circle annotation. Accordingly, as represented in view “F” a circle annotation 308 for the object is rendered around the point of interest 304, which produces the annotated object 310.

Having discussed example details of the techniques for object annotations, consider now some example procedures to illustrate additional aspects of the described techniques.

### Example Procedures

This section describes example procedures in accordance with one or more implementations. Aspects of the procedures may be implemented in hardware, firmware, or software, or a combination thereof. The procedures are shown as a set of blocks that specify operations performed by one or more devices and are not necessarily limited to the orders shown for performing the operations by the respective blocks. In at least some embodiments the procedures may be performed by a suitably configured device, such as the example computing device 102 of FIG. 1 that includes or makes use of an annotation module 110 and/or a client application module 108. Aspects of the procedures may also be performed via a web applications 118 and/or an annotation service 120 available from a service provider 106 over a network.

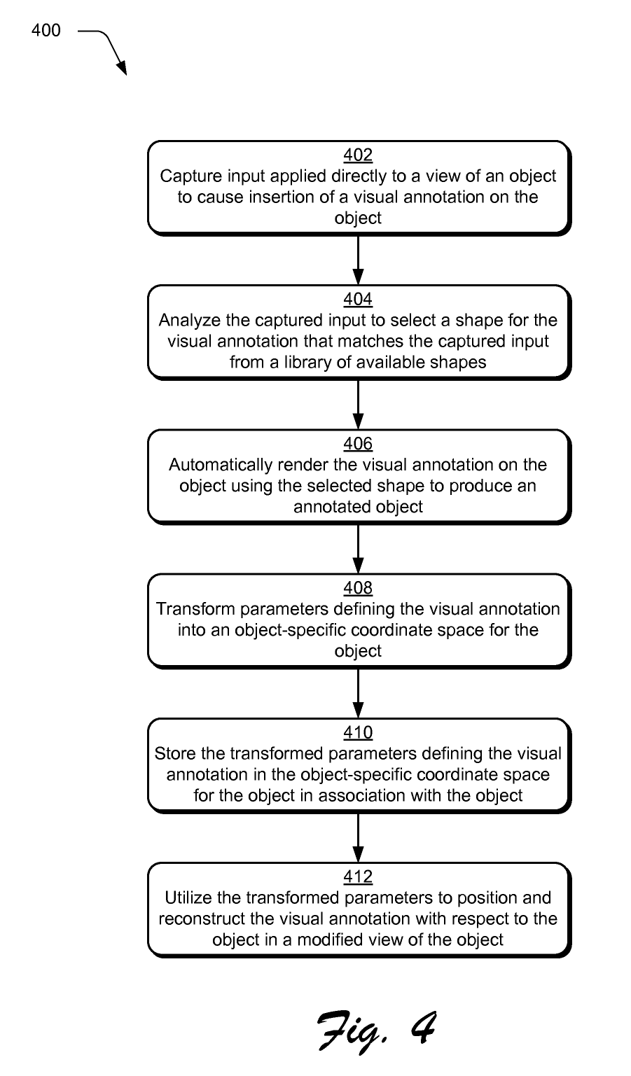

FIG. 4 is a flow diagram depicting an example procedure 400 for rendering and storing an annotation for an object in accordance with one or more implementations. Input applied directly to a view of an object is captured to cause insertion of a visual annotation on the object (block 402). For example, an annotation module 110 may be implemented to capture input associated with annotation of object in various way. In one or more implementations, a user may select a control such as an annotation button to toggle annotation on or off. In addition or alternatively, the annotation module 110 may be configured to enable an annotation mode automatically by default for an application.

When annotations are enabled by default, through a user selection of a control or otherwise, interaction with an object presented in a user interface may be monitored to detect and capture input sufficient to trigger insertion of a visual annotation on the object. Various kinds of objects may be annotated including but not limited to graphical objects such as charts, graphs, and photographic images; and other types of object such as documents, webpages, and the like. The input may be provided as touch-based interaction to draw directly within a view of the object shown in the user interface. In addition or alternatively, the input may involve manipulation of a cursor via an input device (e.g., a mouse, stylus, touchpad, keyboard, etc.) to draw within the view. As noted, relatively simple input patterns (line, arc, l-shape, etc.) may be associated with corresponding visual annotations. Accordingly, the input that a user provides may correspond to an input patterns that the user would like to add to the object.

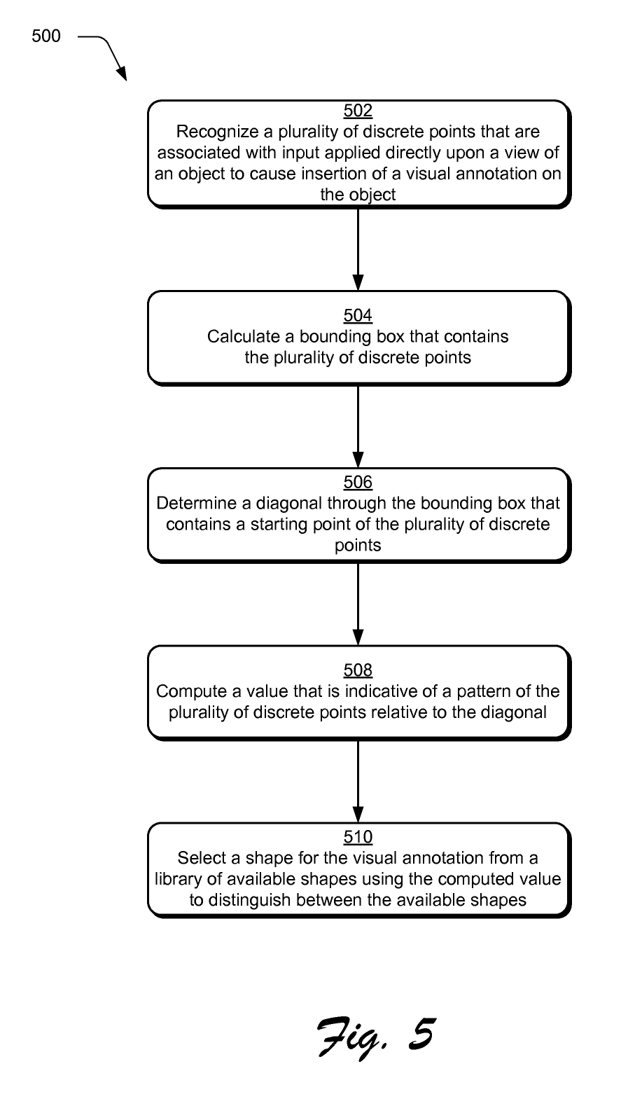

The captured input is analyzed to select a shape for the visual annotation that matches the captured input from a library of available shapes (block 404). The selection of a shape based on the captured input may occur in any suitable way. In one approach, a pattern of discrete points is derived based upon the captured input and compared to signature patterns associated with available shapes for different visual annotations. The different shapes available for visual annotations as well as corresponding signature patterns may be referenced from a library of shapes. The library may contain a pre-defined set of default or system shapes. In addition or alternatively, some custom user shapes may by defined and added to the library. The library may be implemented as a component of an annotation module 110 or as a stand-alone data-file or database that is accessible via the annotation module 110 to analyze capture input. In addition or alternatively, the library may be accessible from a remote locations such as being exposed to clients as part of an annotation service 120 provided by a service provider 106. Additional details regarding techniques that may be employed to select a shape for a visual annotation are discussed in relation to the example procedure of FIG. 5 below.

The visual annotation is automatically rendered on the object using the selected shape to produce an annotated object (block 406). Here, the visual annotation having a shape determined based on the captured input is rendered on the object. Generally, the position where the annotation is placed in the view of the object corresponds to a location within the view where the captured input is applied. For instance, a visual annotation that is configured as an arrow shape may be drawn responsive to input having a line pattern as shown in FIG. 2. In this example, the arrow is drawn in a position that corresponds to the position in the view of the object at which the input occurs. Additionally, the annotation may be rendered in an orientation that is based on the captured input. Thus, the arrow in FIG. 2 is rendered from point x to point y in accordance with the finger drag between those points to cause the annotation.

In order to quickly show the annotation and/or provide immediate feedback, the annotation may initially be associated with and rendered with respect to a coordinate space for the view of the object. The coordinate space for the view of the object may correspond to a coordinate space for a display device on which the view is presented, a coordinate space for a user interface window/shell for the application being used to view the object, and operating system window coordinate space, and so forth. In addition, the captured input may be detected in the coordinate space for the view. Here, parameters defining the annotation including Cartesian coordinates to position the annotation, starting and ending points, size indicators for the object and annotation, shape indicators, drawing commands, and so forth may be expressed relative to the coordinate space for the view. Additional parameters describing annotation characteristics may also be associated with the annotation such as line weights, color, a textual description or tag, behaviors, and so forth. Because the coordinate space of the view is used initially, a selected annotation may be placed directly at the position of the touch-input (or other input). Moreover, the selected annotation may be placed without substantial processing or conversion or parameters defining the annotation, which enables the initial rendering of an annotation shape to occur relatively quickly (e.g., substantially in real-time as the user is drawing on the object).

Additionally, display of the annotation in the coordinate space of the view may enable the user to preview the selected shape. For instance, a predicted shape may be rendered as the user draws. Further, the user may be provided an option selectable to keep or discard the annotation after it is rendered. For example, a dialog or pop-up window may be output having an “Ok” button operable to keep the annotation and a “Cancel” button operable to discard the annotation. In addition or alternatively, tapping on the annotation in a touch based input scenario may be configured to toggle between keeping or discarding the annotation. Likewise, one or more buttons/keys of an input device may be associated with actions to keep and discard the annotation. Various other user interface instrumentalities and controls may also be employed to implement the option to keep or discard a displayed annotation. Additionally, the user may also be able to manipulate the visual annotation in various ways after it is displayed, such as by changing size, repositioning, and/or adding descriptive text or labels, to name a few examples.

If the user chooses to discard the annotation via the option, the rendering of the annotation is removed/un-done and the user may subsequently provide further input to create or select a different available annotation. On the other hand, if the user chooses to keep the annotation via the option, the annotation may be finalized. In addition or alternatively, finalization of the annotation may be triggered automatically based on a timer that begins after the user concludes drawing action, such as by lifting their finger in a touch-based scenario or releasing a button of an input device used to provide the input.

Once the annotation is finalized, parameters defining the visual annotation are transformed into an object-specific coordinate space for the object (block 408) and the transformed parameters defining the visual annotation are stored in the object-specific coordinate space for the object in association with the object (block 410). As noted above, input defining a visual annotation may be initially captured and used in a coordinate space of the view to quickly render a corresponding annotation shape without substantial processing. Once a user makes a selection to finalize the annotation, final parameters defining the visual annotation in the coordinate space of the view may be retrieved that are updated to reflect any changes made to the initially rendered annotation, such as changing the shape, size, or position; adding text; and so forth.

In order to tie the annotation to the object itself, the final parameters for the annotations are transformed into an object-specific coordinate space. For instance, Cartesian coordinates to position the annotation, the starting and ending points, size indicators, drawing commands, and other parameters may be converted from values in a view-based coordinate space associated with a display device/touch digitizer, graphical user interface, and/or particular applications, to values in the object-specific coordinate space. In one approach, the transformation may occur by computing offsets for coordinates between the view-based and object-specific coordinate spaces and applying the offsets to derive coordinates for the final parameters in the object-specific coordinate space. For example, if a chart origin is positioned at x-y or pixel coordinates of 100, 200 in the view space, then offsets values of 100 and 200 may be computed for the transformation. Accordingly, an annotation centered in the view space at coordinates of 250, 350 may be transformed to have a center of 150, 250 in the object specific space based on the offsets. In some cases, a scaling factor between the view-based and object-specific coordinate spaces may also be computed and applied. The scaling factor is configured to reflect relative sizes of the object and the view. Moreover, in the case of a graphical chart having underlying data, the scaling factor may be used to map pixel values in the view space to values on coordinate axes in the object specific coordinate space. This enables values for the data points of the underlying chart data at the position of the annotation to be retrieved. For instance, in the example of FIG. 2, data values indicative of the month of September and a dollar amount for the corresponding bar of the chart may be determined based on transformation of the annotation parameters into the object-specific coordinate space.

The transformed parameters including at least the pixel values and data point values if appropriate in the object-specific coordinate space are then stored in association with the object. The association may be established in any suitable way. For example, the transformed parameters defining the annotation may be embedded within the object as metadata. In addition or alternatively, the transformed parameters may be serialized in a script-based string associated with the object. In an implementation the script-based string is configured as a JavaScript Object Notation (JSON) string. In another example, an external data file or object that contains the metadata and/or the script-based string is generated and linked to the object. The external data file having the transformed parameters may be linked via a URL, tag, header field, script command, or other suitable construct that facilitates access to and retrieval of the transformed parameters from the file.

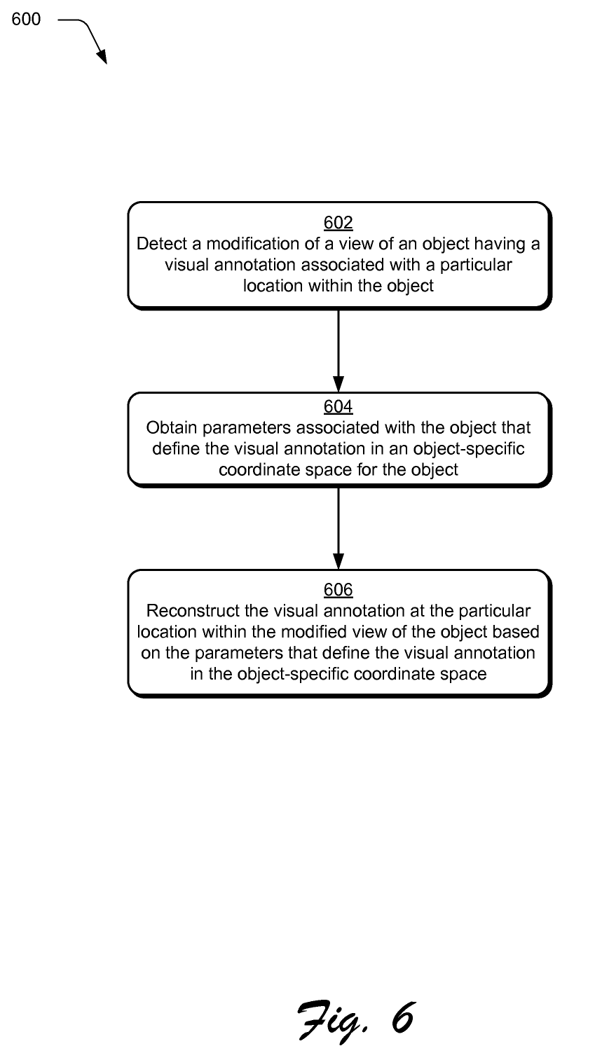

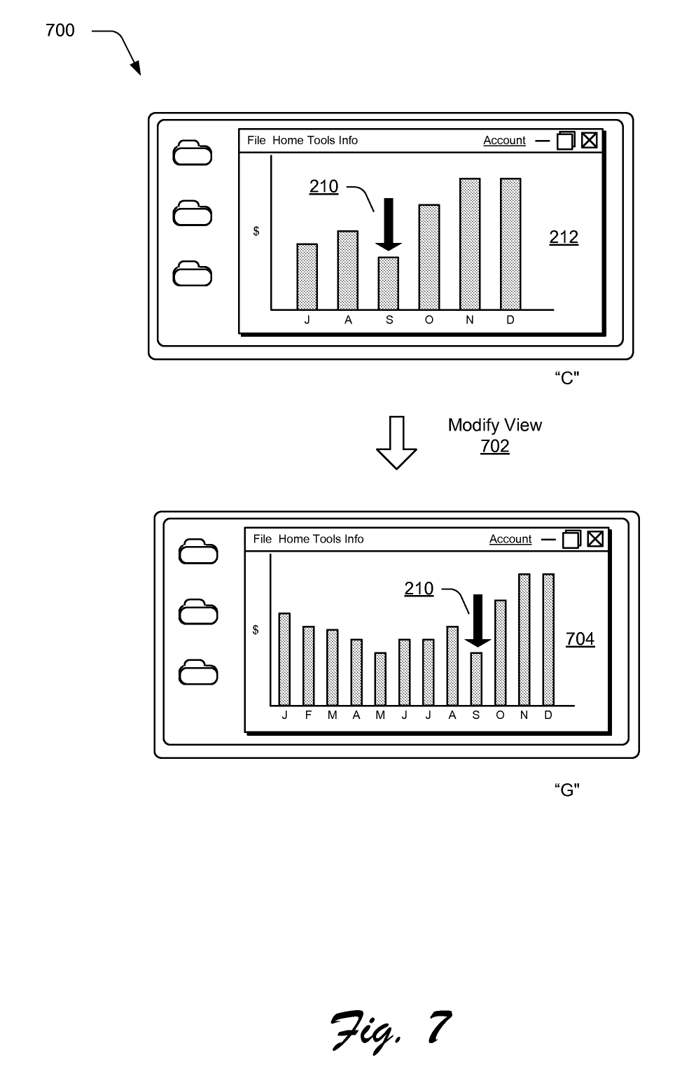

Thereafter, the transformed parameters are utilized to position and reconstruct the visual annotation with respect to the object in a modified view of the object (block 412). In general, the transformed parameters stored in association with an object are sufficient to reconstruct and position the corresponding annotation when the object is subsequently displayed. Because the parameters are stored relative to the object-specific coordinate space and are tied to underlying chart or pixel data for the object, the annotation can be positioned correctly within the object even when the view if modified. For example, if a user scrolls to a different section of the bar graph shown in FIG. 2 or changes the scale, the arrow annotation remains tied to the bar for September. Likewise, if the photographic image shown in FIG. 3 is resized, the circle annotation remains tied to the underlying pixels of the image and accordingly remains centered with respect to the point of interest (e.g., skin blemish region) in the image. Further details regarding reconstruction of an annotation in modified view are discussed in relation to FIGS. 6 and 7 below. First, however, example details of techniques to select a shape based on captured input are discussed in relation to the example procedure shown in FIG. 5.

In particular, FIG. 5 is a flow diagram depicting an example procedure 500 for selection of an annotation shape based on an input pattern in accordance with one or more implementations. A plurality of discrete points are recognized that are associated with input applied directly upon a view of an object to cause insertion of a visual annotation on the object (block 502). For instance, input may be captured in various ways examples of which were discussed previously herein in relation to the example procedure of FIG. 4 and elsewhere. Generally the input is captured as a plurality of discrete points that track user interaction with an object either by touch or manipulation of a cursor using an input device. The pattern of discrete points may be analyzed to recognize the pattern and map the pattern to known, signature patterns for different annotations to automatically pick a corresponding visual annotation. Comparison of a detected pattern to signature patterns may occur in various ways, one example of which is a bounding box approach represented in FIG. 5. Other examples may include overlaying patterns one to another to detect matches, fitting equations to the patterns, applying optical character recognition techniques to the patterns, and other computations suitable to distinguish between different patterns of input.

In the bounding box example of FIG. 5, a bounding box is calculated that contains the plurality of discrete points (block 504) and a diagonal through the bounding box is determined that contains a starting point of the plurality of discrete points (block 506). Then, a value is computed that is indicative of a pattern of the plurality of discrete points relative to the diagonal (block 508). In this example, the diagonal of the bounding box is used as a reference feature that is used to assess the pattern of the points of input. For example, distances of each point to the diagonal may be calculated and an average distance may be obtained. The average distance may be indicative of the general shape of the capture input. In particular, a box that contains the set of discrete points is logically constructed. For a substantially straight line, the box may be narrow and distances of points to the diagonal may be relatively small. On the other hand, the box for a circle or l-shape will be somewhat wider than for the straight line and the average distance to the diagonal may be correspondingly larger. Accordingly, the average distance of points to the diagonal of a bounding box is one metric that may be used to distinguish between different patterns. In an implementation, the average distance may be divided by a length of the diagonal to produce a distance ratio. Different shapes/annotations may be associated with different distance ratio values. For example, in an implementation, a ratio of 0.2 or less may be associated with an arrow shape whereas ratios above 0.2 may be indicative of circle/ellipse. Although a diagonal of a bounding box is described, different reference features as well as combinations of features may be used in different implementations. Further, values other than average distance may be computed and used as metrics for detection of input patterns such as a distribution value, a standard deviation, and/or normalized box dimensions, to name a few examples.

A shape is selected for the visual annotation from a library of available shapes using the computed value to distinguish between the available shapes (block 510). Here, one or more computed values are used as metrics to select shapes. Generally, available shapes in a library of shapes each have signature patterns for which corresponding metrics are evaluated. Matching of captured input to shapes in the library may therefore involve comparing the computed values to corresponding, signature values for shapes in the library. For example, distance ratio values may be compared to distinguish between arrow and ellipse shapes as noted above.

FIG. 6 is a flow diagram depicting an example procedure 600 for reconstruction of an annotation in a modified view in accordance with one or more implementations. A modification is detected of a view of an object having a visual annotation associated with a particular location within the object (block 602). For example, an annotation may be generated and associated with an object using the techniques discussed in relation to the preceding figures. For instance, a visual annotation may be placed at a particular location within a chart or image according to direct interaction of user with the chart or image. The visual annotation may also be tied to underlying object data such as pixel values for the chart or the image, and/or data point values for the chart when appropriate. This may be accomplished by transforming parameters defining the annotation into an object-specific coordinate space and storing the parameters in association with the object. Parameters may be embedded within the object, serialized in a JSON string or other script-based string, recorded in a data file, or otherwise associated with the object.

The visual annotation may be created with respect to a particular view of an object. For example, a view of a chart may be presented with particular ranges for chart axes and data. In the case of an image, the view may correspond to a zoom-level or particular sizing of the image. For some objects, a user may choose to modify the view. For example, an image, chart or other object may be resized to produce a modified view. Additionally, a data range or scale for a chart may be modified to present a modified view. For instance, the object may be configured as a time-based graphical chart having a time-based axis to represent data for a selected time frame. Here, the modification may involve changing a time scale of the time-based graphical chart to show a different time frame for data presented by the time-based graphical chart.

When a modification of the object occurs, the annotation module 110 may detect the modification. In response to the detection, the annotation module 110 may perform operations to position and/or reconstruct the annotation for the modified view. To do so, the annotation module 110 may access and use the parameters defining the annotation in the object-specific coordinate space to draw the annotation and locate the annotation correctly with respect to underlying data to which annotation was initially tied.

In particular, parameters are obtained that define the visual annotation in an object-specific coordinate space for the object that are associated with the object (block 604). Then, the visual annotation is reconstructed at the particular location within the modified view of the object based on the parameters that define the visual annotation in the object-specific coordinate space (block 606). For example, parameters that define the visual annotation may be accessed from object metadata, a data file, a script-based string or other construct configured to contain the parameters for the annotation and associate the parameters with the object. In an implementation, the parameters include drawing instructions that enable the annotation module 110 to direct rendering of the annotation with the correct shape and at the particular location within the modified view of the object. Parameters that indicate the relationship of the annotation to underlying object data may be used to ensure that the annotation appears in proper relation to features, chart data points, or other points of interest within the object to which the annotation was attached in the original view. In this way, annotations maintain correct positioning relative to the object as a user interacts to switch between different views.

To further illustrate techniques for reconstruction of an annotation as a view changes, consider now an illustrative example depicted in FIG. 7. In particular, FIG. 7 illustrates an example scenario in which an annotated object is modified in accordance with one or more implementations, generally at 700. The depicted example represents modification of the view “C” of an annotated object 212 as generated per FIG. 2 and using the techniques described herein. In particular, the example annotation 210 in the form of an arrow is shown as being associated with a bar labeled “S” in the annotated object 212. The annotated object 212 here is configured as a bar graph that shows a monthly view of a monetary value (a cost or revenue value for example), and the “S” corresponds to September. In view “C”, the scale of the graph is set to six months or half a year.

Now consider a situation in which a manager of a business wants to highlight the low dollar value in September shown in the chart. To do so, the manager may add the annotation 210 in the form of an arrow as per FIG. 2. Additionally, the annotation may be stored in relation to an object-specific coordinate space for the object, which ties the annotation to underlying data in the chart. Now, if the manger accesses and decides to modify the view, the arrow annotation will remain tied to the bar labeled “S” in graph.

In particular, FIG. 7 represents an action 702 to modify the view “C”. In this example, the modification is changing of the time scale of the bar graph from six months to a year as shown in view “G”. In the modified object 704, the annotation 210 in the form of an arrow remains associated with the bar labeled “S” even though the scale is changed. The annotation 210 may be positioned and reconstructed based on parameters that define the annotation in the object specific coordinate space. By doing so, the annotation 210 is tied to the underlying data for the chart rather than being overlaid on and/or positioned relative to a particular view of the chart. Thus, the annotation is shown along with the correct data points and/or pixels of the object as the object is modified to show different views.

Having described example procedures in accordance with one or more implementations, consider now a discussion of example systems and devices that can be utilized to implement the various techniques described herein.

### Example System and Device

FIG. 8 illustrates an example system generally at 800 that includes an example computing device 802 that is representative of one or more computing systems and/or devices that may implement the various techniques described herein. This is illustrated through inclusion of the annotation module 110, which operates as described above. The computing device 802 may be, for example, a server of a service provider, a device associated with a client (e.g., a client device), an on-chip system, and/or any other suitable computing device or computing system.

The example computing device 802 is illustrated as including a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media does not include signals per se or signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although techniques have been described in language specific to structural features and/or methodological acts, it is to be understood that the subject matter defined in the appended claims is not necessarily limited to the specific features or acts described. Rather, the specific features and acts are disclosed as example forms of implementing the claimed subject matter.

What is claimed is:

1. A method implemented by a computing device, the method comprising:
capturing input applied directly to a view of an object to cause insertion of a visual annotation on the object;
analyzing the captured input to select a shape for the visual annotation that matches the captured input from a library of available shapes;
automatically rendering the visual annotation on the object using the selected shape to produce an annotated object; and
transforming parameters defining the visual annotation into an object-specific coordinate space for the object; and
storing the transformed parameters defining the visual annotation in the object specific coordinate space in association with the object.

2. The method of claim 1, further comprising utilizing the transformed parameters to position and reconstruct the visual annotation with respect to the object in a modified view of the object.

3. The method of claim 1, wherein the input comprises touch-based interaction to draw within the view.

4. The method of claim 1, wherein the input comprises manipulation of a cursor via an input device to draw within the view.

5. The method of claim 1, wherein the object comprises a graphical chart.

6. The method of claim 1, wherein the object comprises a photographic image.

7. The method of claim 1, wherein storing the transformed parameters in association with the object comprises embedding the transformed parameters within the object as metadata.

8. The method of claim 1, wherein storing the transformed parameters in association with the object comprises serializing the transformed parameters in a script-based string associated with the object.

9. The method of claim 8, wherein the script-based string comprises a JavaScript object notation (JSON) string.

10. The method of claim 1, wherein capturing the input applied directly to the view includes recognizing a plurality of discrete points generated by the input in a coordinate space of the view, the plurality of discrete point indicative of the shape and position of the a visual annotation.

11. A method as described in claim 10, wherein analyzing the captured input to select the shape for the visual annotation that matches the captured input comprises:
calculating a bounding box that contains the plurality of discrete points;
determining a diagonal through the bounding box that contains a starting point of the plurality of discrete points;
computing a value indicative of a pattern of the plurality of discrete points relative to the diagonal; and
selecting a shape for the visual annotation from the library of available shapes using the computed value to distinguish between the available shapes.

12. The method of claim 10, wherein transforming the parameters into the object-specific coordinate space for the object includes deriving the parameters in the coordinate space of the view based on the plurality of discrete points and transforming the parameters from the coordinate space of the view into the object-specific coordinate space.

13. One or more computer-readable storage media comprising instructions stored thereon that, responsive to execution by a computing device, cause the computing device to implement an annotation module configured to perform operations including:
recognizing a plurality of discrete points associated with input applied directly upon a view of an object to cause insertion of a visual annotation on the object;
calculating a bounding box that contains the plurality of discrete points;
determining a diagonal through the bounding box that contains a starting point of the plurality of discrete points;
computing a value indicative of a pattern of the plurality of discrete points relative to the diagonal; and
selecting a shape for the visual annotation from the library of available shapes using the computed value to distinguish between the available shapes.

14. One or more computer-readable storage media as described in claim 13, library of available shapes includes at least an arrow shape and a circle shape.

15. One or more computer-readable storage media as described in claim 13, wherein the annotation module is further configured to perform operations including:
producing an annotated object by automatically rendering the visual annotation on the object within the view using the selected shape; and
storing information regarding the selected shape and position of the visual annotation as metadata for the annotated object to enable reconstruction of the visual annotation in a modified view of the object, the information regarding the selected shape and position stored in an object-specific coordinate space for the object.

16. One or more computer-readable storage media as described in claim 13, wherein the value indicative of the pattern of the plurality of discrete points comprise an average distance from the plurality of discrete points to the diagonal through the bounding box.

17. A computing device comprising:
a processing system;
one or more computer readable media storing instructions executable via the processing system to perform operations comprising:
detecting a modification of a view of an object having a visual annotation associated with a particular location within the object;
obtaining parameters indicative of a shape and position of the visual annotation and defined in an object-specific coordinate space for the object; and
reconstructing the visual annotation at the particular location within the modified view of the object based on the parameters defined in the object-specific coordinate space.

18. The computing device as described in claim 17, wherein the parameters indicative of the shape and position are obtained from a JavaScript object notation (JSON) string embedded in the object that contains the parameters.

19. The computing device as described in claim 17, wherein the object comprises a time-based graphical chart and the modification comprises changing a time scale of the time-based graphical chart to show a different time frame for data presented by the time-based graphical chart.

20. The computing device as described in claim 17, wherein the object comprises an image and the modification comprises resizing the image.
